(19) United States
(12) Patent Application Publication
(10) Pub. No.: US 2007/0045521 A1
(43) Pub. Date: Mar. 1, 2007

(54) Optical distribution module and signal processing device

(75) Inventors: Junji Okada, Kanagawa (JP); Shinobu Ozeki, Kanagawa (JP); Jun Kitamura, Kanagawa (JP); Seiji Suzuki, Kanagawa (JP); Takeshi Kamimura, Kanagawa (JP); Yoshihide Sato, Kanagawa (JP); Masaru Kijima, Kanagawa (JP); Osamu Ohtani, Kanagawa (JP); Norihiko Kuroishi, Kanagawa (JP); Tomo Baba, Kanagawa (JP); Hisayoshi Mori, Kanagawa (JP); Tsutomu Hamada, Kanagawa (JP); Takehiro Niitsu, Kanagawa (JP); Shinya Kyozuka, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/337,656

(22) Filed: Jan. 24, 2006

(30) Foreign Application Priority Data
Aug. 23, 2005 (JP) 2005-241183

(51) Int. Cl. H01J 3/14; H01J 5/16

(52) U.S. Cl. 250/216

(57) ABSTRACT

An optical distribution module includes at least one light emitting element that converts an optical signal to an electrical signal, at least one light receiving element that converts the optical signal to the electrical signal, and a distribution circuit that is arranged so as to optically couple the light emitting element and the light receiving element. The distribution circuit branches or couples the optical signal from the light emitting element so as to emit the optical signal to the light receiving element.

### CROSS-REFERENCE TO RELATED APPLICATION

This application is based on and claims the benefit of priority from the prior Japanese Patent Application No. 2005-241183, filed on Aug. 23, 2005; the entire contents of which are incorporated herein by reference.

### BACKGROUND OF THE INVENTION

1. Technical Field of the Invention

The present invention relates to an optical distribution module for converting electrical signals to optical signals to conduct branching (branching of waves) or coupling of optical waves, and a signal processing device for the same.

2. Description of the Related Art

With the recent development of a very large scale integration (VLSI), functions of circuit boards to be used in a data processing system or the like have been remarkably increased. With the increase of the functions of the circuit boards, connections of signals to the respective circuit boards (daughter boards) have been increased in number. Therefore, in a data bus board (mother board) which interconnects the circuit boards by a bus structure, a parallel architecture requiring a large number of connectors and connecting lines has been employed.

In the bus connection system, because characteristic impedance of electricity transmitting wires has been varied due to bus connection, and multi-reflection has occurred which might have hindered high speed transmission. However, by employing a point-to-point connection system, the high speed transmission has become possible. For example, Serial ATA Working Group is going to standardize a rate of 1.5 to 6 Gbps.

Nevertheless, although the point-to-point connection system is advantageous in connecting a pair of LSI to each other, in case where connection of 1:N such as connection between a CPU and memories is required, 1/O number of pins in the CPU will be inevitably increased.

On the other hand, in order to enhance operation speed of the signal transmission, it has been considered to employ an in-system optical connection technique which is called as optical interconnection. For example, there has been known an optical interconnection device which has various components including a light emitting element such as a vertical cavity surface emitting laser (VCSEL), a driver IC for driving the light emitting element, a light receiving element such as a photodiode, and a receiver IC for driving the light receiving element, and light guide paths for transmitting optical signals, which are provided on an optical and electrical combined board.

Moreover, an optical transmission module in which the light emitting element, the light receiving element, and a transmitting and receiving circuit are contained in a package to conduct transmission to the exterior through an optical fiber has been also known.

By the way, speaking of a boundary between the optical and electrical interconnections, transmission of a few Gbps can be made by the electrical transmission, in case where a transmitting distance is relatively short (up to 1 m or so), as shown in Document 1 unrelated to Patent. On the other hand, the optical interconnection is required in a region of more than a few Gbps.

Because the optical interconnection is generally expensive as compared with the electrical transmission, it is reasonable to construct the system by the electrical transmission in a region to which the electrical transmission can be applied, and by the optical transmission in a region to which the electrical transmission cannot be applied.

Moreover, in case where a backplane (a circuit board or a device at a receiving side which has sockets or slots to be connected to circuit boards) to be connected to a plurality of daughter boards in which the connection of 1:N is required is constructed for a transmitting distance of about 50 cm, there is a problem, as described above, in performing the high speed transmission only with the electrical interconnection.

Under the circumstances, it has been proposed to construct the optical interconnection of 1:N.

### SUMMARY OF THE INVENTION

However, according to the above-related art, optical elements of various types must be individually incorporated on the optical and electrical combined board, which makes the structure complicated, and downsizing of the device cannot be achieved. According to the above-related art, it is necessary to perform connection between a CPU and memories by optical fibers, which may incur an increase of cost. According to the above-related art, in case where couplers are used to conduct data transmission between the circuit boards, the number of optical fibers connected to light emitting and receiving elements will be increased, and there is a problem that the structure will be complicated and the device will be large-sized.

It is an object of the invention to provide an optical distribution module which has a small size and enables high speed transmission to be conducted, in connection of 1:N, and a signal processing device employing the same.

According to an aspect of the invention, an optical distribution module includes at least one light emitting element that converts an optical signal to an electrical signal, at least one light receiving element that converts the optical signal to the electrical signal, and a distribution circuit that is arranged so as to optically couple the light emitting element and the light receiving element. The distribution circuit branches or couples the optical signal from the light emitting element so as to emit the optical signal to the light receiving element.

According to another aspect of the invention, an optical distribution module includes at least one light emitting element array having a plurality of light emitting elements that convert an optical signal to an electrical signal, at least one light receiving element array having a plurality of light receiving elements that convert the optical signal to the electrical signal, and a distribution circuit that is arranged so as to optically couple the light emitting element array and the light receiving element array. The distribution circuit braches or couples the optical signal from the light emitting element array so as to emit the optical signal to the light receiving element array.

According to still another aspect of the invention, a signal processing device includes a board on which the optical distribution module according to the above-aspects is mounted. The board transmits and receives the electrical signal to and from the optical distribution module.

According to still yet another aspect of the invention, a signal processing device includes a mother board on which the optical distribution module according to the above-aspects and a CPU are mounted and a plurality of memory boards being connected to the mother board. The plurality of memory boards has a semiconductor memory.

According yet another aspect of the invention, a signal processing device includes a mother board on which the optical distribution module according to the above-aspects is mounted, a plurality of memory boards being connected to the motherboard, and a CPU board. The plurality of memory boards has a semiconductor memory. The CPU board carries a CPU. The CPU is connected to the mother board.

### BRIEF DESCRIPTION OF THE DRAWINGS

These and other objects and advantages of this invention will become more fully apparent from the following detailed description taken with the accompanying drawings in which:

FIG. 1 is a perspective view showing an optical distribution module according to a first embodiment of the invention.

FIGS. 2A, 2B show a structure of light guide body in FIG. 1, in which 2A is a plan view, and 2B is a front view.

FIGS. 3A, 3B are explanatory views showing light paths of the optical distribution module in the first embodiment, in which 3A is a plan view, and 3B is a front view.

FIG. 4 is a perspective view showing an optical distribution module according to a second embodiment of the invention.

FIG. 5 is a perspective view showing an optical distribution module according to a third embodiment of the invention.

FIG. 6A is a front view of an optical distribution module according to a fourth embodiment of the invention, and FIG. 6B is a front view of an optical distribution module according to a fifth embodiment of the invention.

FIG. 7 is a perspective view showing a signal processing device according to a sixth embodiment of the invention.

FIG. 8 is a perspective view showing a signal processing device according to a seventh embodiment of the invention.

### DESCRIPTION OF THE EMBODIMENTS

### First Embodiment

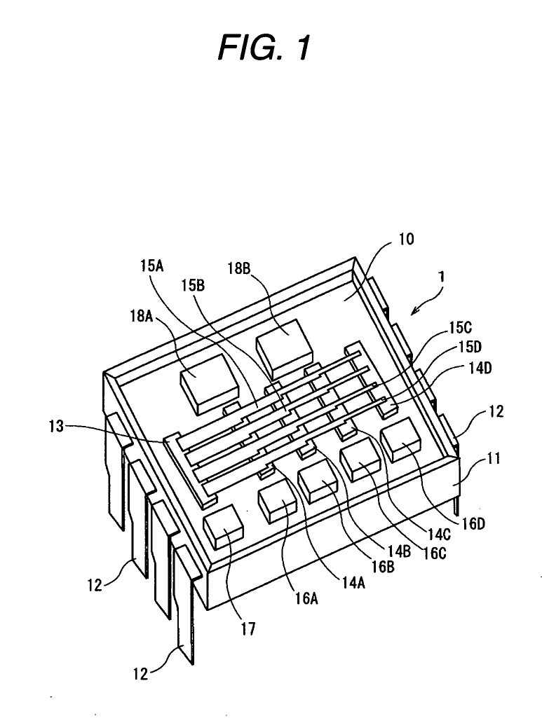

FIG. 1 shows an optical distribution module according to a first embodiment of the invention. This optical distribution module 1 has a board 10 held in a package 11, and a plurality of grid pins 12 which are guided out from both sides of the package 11.

The board 10 has an electrically conductive pattern on a surface of a substrate formed of resin. On the board 10, there are arranged a vertical cavity surface emitting laser (VCSEL) array 13 as a light emitting element array for converting electrical signals to optical signals, a first to fourth photodiode (PD) arrays 14A to 14D as light receiving element arrays for converting the optical signals to electrical signals, a plurality of light guide bodies 15A to 15D, as distribution circuits for branching the optical signals from the VCSEL array 13, which are provided so as to optically couple the VCSEL array 13 and the PD arrays 14A to 14D, a plurality of trans impedance amplifiers (TIA) 16A to 16D for converting electric currents from the PD arrays 14A to 14D to electrical pressures and amplifying them, and a laser driver 17 for driving the VCSEL array 13, and control ICs 18A, 18B for controlling the TIA 16A to 16D and the laser driver 17.

The grid pins 12 are connected to components or wiring patterns mounted on the board 10, and adapted to be connected to wiring patterns on circuit boards or a mother board of an apparatus or device, when the optical distribution module is mounted on the circuit boards or the mother board. The number of the grid pins 12 can be optionally selected, although the four grid pins 12 are respectively provided on both the side faces, in this embodiment.

The VCSEL array 13 has four VCSELs. The VCSEL has a wavelength of 85 nm, and a radiation angle of 17° (prescribed from a strength of 1/e² with respect to the maximum strength), and a pitch of elements is 250 μm, for example.

The first to fourth PD arrays 14A to 14D have the same structure, and respectively have four PDs having a receiving diameter of 80 μm. The PD arrays 14A to 14D are arranged below the light guide bodies 15A to 15D so as to correspond to respective inclined faces (mirror faces) of the light guide bodies 15A to 15D which will be described below. A pitch of the respective elements of the PD arrays 14A to 14D is, for example, 250 μm.

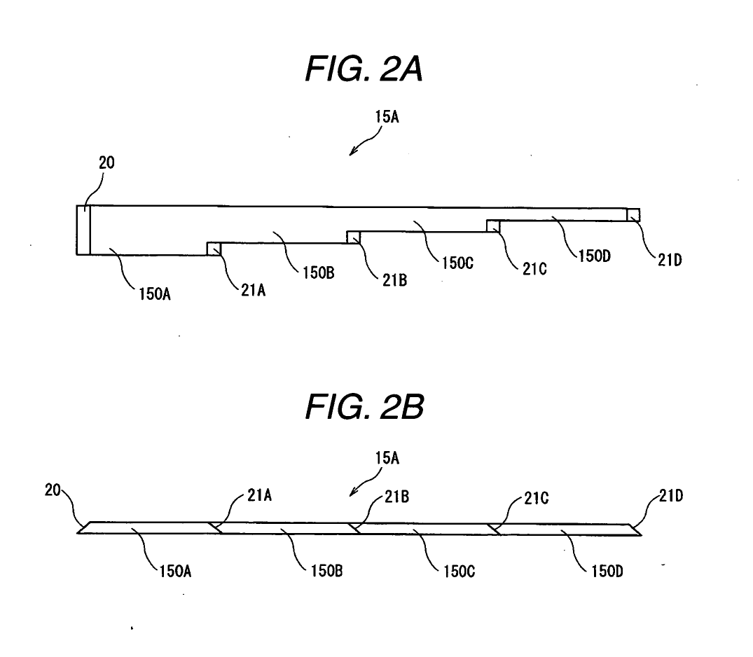

FIGS. 2A, 2B show a structure of the light guide body in FIG. 1. In FIG. 2A is a plan view, and 2B is a front view. Because the light guide bodies 15A to 15D have the same shape, the light guide body 15A only will be herein described.

The light guide body 15A has a thickness of 0.05 mm, a largest length of 14.05 mm, a largest width of 0.2 mm, and a smallest width of 0.05 mm. Moreover, the width of the light guide body 15A is reduced at respective positions superposed on the PD arrays 14A to 14D thereby to have four steps as a whole. For example, a first step is formed at a position of 3.55 mm from a starting end of the largest width, a second step at a position of 3.5 mm from the first step, a third step at a position of 3.5 mm from the second step, and a fourth step at a position of 3.5 mm from the third step. Light guide paths 150A to 150D are formed according to the lengths defined by the respective steps.

A light incident end (a leftward end in FIG. 2A) of the light guide body 15A and respective ends of the light guide paths 150A to 150D have inclined faces which are cut at an angle of 45°, thereby to form mirror faces 20, 21A, 21B, 21C, and 21D. The mirror face 20 is a light incident face, and the mirror faces 21A to 21D are light emitting faces.

As material for the light guide body 15A, plastic material such as polymethyl methacrylate, polycarbonate, amorphous polyolefin, and inorganic glass, etc. may be used. The light guide body 15A formed of the plastic material can be produced by injection molding or other processes. In case where the inorganic glass is used as the material for the light guide body 15A, the mirror faces 20, and 21A to 21D can be formed by grinding work. Further, it is possible to produce the light guide body 15A from epoxy resin or the like of ultraviolet setting type, using a determined mold.

(Operation of Optical Distribution Module)

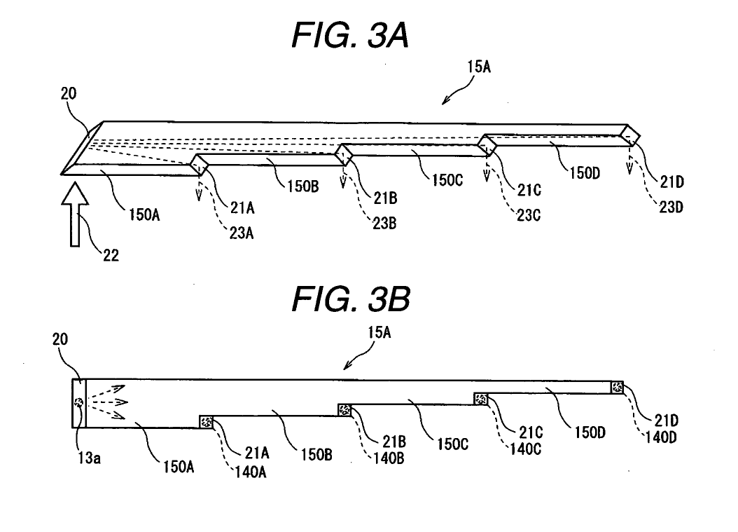

FIGS. 3A, 3B show light paths of the optical distribution module in the first embodiment. Referring to FIGS. 3A, 3B and FIG. 1, operation of the optical distribution module 1 will be described. The light guide body 15A will be herein described.

As shown in FIG. 3B, a VCSEL 13a of the VCSEL array 13 is arranged on a lower face of the mirror face 20 of the light guide body 15A. PD 140A, 140B, 140C, 140D of the PD arrays 14A to 14D are arranged on lower faces of the mirror faces 21A to 21D.

The optical distribution module 1 is mounted on a circuit board or the like of a signal processing device. Supply of power, and transmission of data, signals of various kinds and so on will be conducted through the circuit board or the like. The VCSEL array 13 is driven by the control ICs 18A, 18B and the laser driver 17 which are driven according to a signal from the exterior, whereby the VCSEL including the VCSEL 13a inside the VCSEL array 13 will emit light.

A signal light from the VCSEL 13a will enter the mirror face 20 as an incident light 22, as shown in FIG. 3A, and will be reflected by the mirror face 20 in a direction of 90°, and proceeds toward the mirror faces 21A to 21D inside the light guide body 15A, while undergoing total reflection. The signal light arrived at the mirror faces 21A to 21D will be reflected at the right angle in a downward direction to enter the PD 140A to 140D of the PD array 14A to 14D. Consequently, the incident light 22 has been branched to the PD 140A to 140D by way of the mirror faces 21A to 21D.

The PD 140A to 140D will generate electrical signals corresponding to levels of the incident lights, and input the electrical signals into the TIA 16A to 16D. The signals processed by the TIA 16A to 16D will be outputted to the circuit board or the like through either of the grid pins 12.

(Advantage of the First Embodiment)

According to this first embodiment, the following advantages can be obtained.

(a) Because the light guide bodies 15A to 15D for branching the light is modularized, it has become unnecessary to conduct connection between the optical distribution module 1 and other devices or circuits by means of optical fibers. Accordingly, downsizing of the signal processing device employing the optical distribution module can be achieved.

(b) Because the optical signal is branched by the light guide bodies 15A to 15D, high speed transmission has been made possible.

(c) Because the light guide bodies 15A to 15D for branching the light is modularized, it has become easy to design layout of the board on which the optical distribution module is mounted, and various components.

(d) Because the VCSEL array 13 and the PD arrays 14A to 14D are employed, the module can be easily assembled, as compared with a case in which the light emitting elements and light receiving elements are individually arranged, and thus, downsizing of the device can be achieved.

### Second Embodiment

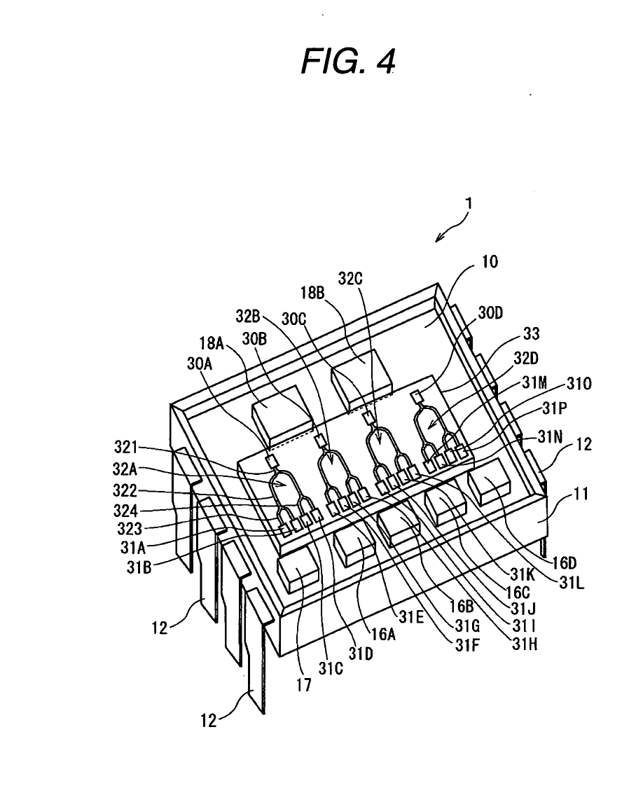

FIG. 4 shows an optical distribution module according to the second embodiment of the invention. In this embodiment, the VCSEL array 13 in the first embodiment is substituted by individual VCSELs 30A to 30D, the PD arrays 14A to 14D are substituted by individual PDs 31A to 31D, and the light guide bodies 15A to 15D are substituted by a single distribution circuit 33. Structures of the other parts are substantially the same as in the first embodiment.

The distribution circuit 33 is constructed by forming Y-shaped branching light guide paths 32A to 32D respectively having two steps of Y-shaped branches, on a sheet of substrate, and mounted on the board 10. The Y-shaped branching light guide paths 32A to 32D of the same structure are so constructed that an optical signal from one VCSEL can be branched into four PDs.

Now, the Y-shaped branching light guide path 32A will be described. The Y-shaped branching light guide path 32A has a light guide part 321 which is connected to the VCSEL 30A at its one end, a Y-shaped light guide part 322 connected to the other end of the light guide part 321, and Y-shaped light guide parts 323, 324 which are respectively connected to other ends of the light guide part 322. To respective ends of the light guide parts 323, 324, the PDs 31A to 31P are connected. The ends of the light guide parts 323, 324 may be formed as faces perpendicular to a longitudinal direction, or as inclined faces.

The distribution circuit 33 may employ a structure of, for example, slab type, embedded type, ridge type, etc. The distribution circuit 33 is produced by forming a core part of the light guide path from acryl resin, epoxy resin or polyimide resin, and then, by forming a clad of fluoric polymer or the like having a smaller index of refraction than the core part, around the core part. Such distribution circuit can be produced by semiconductor process.

In FIG. 4, when the VCSEL 30 is driven, the VCSEL 30A will emit light, in the same manner as the VCSEL in the first embodiment. An optical signal from the VCSEL 30A enters the light guide part 321, and will be branched into two, when it has arrived at the light guide part 322. The optical signal which has been branched into two enters the light guide parts 323, 324 to be branched into four, and enter the PDs 31A to 31D. In this manner, the connection of 1:N will be achieved.

(Advantage of the Second Embodiment)

According to the second embodiment, the Y-shaped branching light guide paths 32A to 32D are modularized. Therefore, downsizing of the signal processing device employing the optical distribution module 1 can be attained in the same manner as in the first embodiment, and it has become easy to design layout of the board on which the optical distribution module is mounted, and the components.

### Third Embodiment

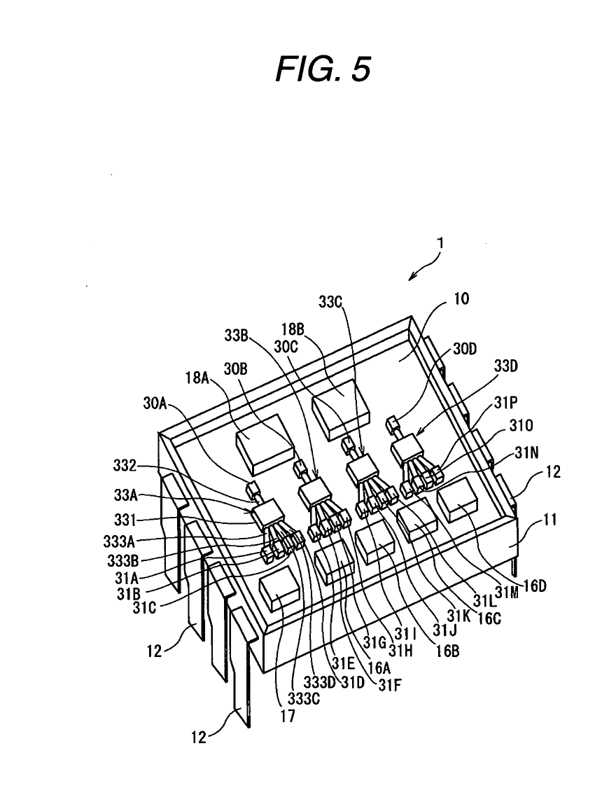

FIG. 5 shows an optical distribution module according to the third embodiment of the invention. In this embodiment, the distribution circuit 33 in the second embodiment is substituted by distribution circuits 33A to 33D each including optical fibers and light guide plates. Structures of the other parts are substantially the same as in the second embodiment.

Because the distribution circuits 33A to 33D have the same structure, explanation will be made with respect to the distribution circuit 33A. The distribution circuit 33A has a light guide plate 331 capable of branching at 1:N (N=4, in this embodiment), an optical fiber 332 which connects the light guide plate 331 to the VCSEL 30A, and optical fibers 333A to 333D which connect the light guide plate 331 to the four PDs 31A to 31D individually.

As material for the light guide plate 331, plastic material such as polymethyl methacrylate, polycarbonate, amorphous polyolefin, or inorganic glass or the like may be employed.

Connection of the optical fibers 332 and 333A to 333D to the VCSEL 30A and the PDs 31A to 31D can be performed by bonding or optical couplers or the like.

In FIG. 5, when the VCSEL 30A has emitted light, the light from the VCSEL 30A enters the optical fiber 332, and then, enters the light guide plate 331. The light guide plate 331 will diffuse the incident light from the optical fiber 332 to enter the light into the optical fibers 333A to 333D. The lights from the optical fibers 333A to 333D enter the PDs 31A to 31D, and will be converted into electrical signals by the PDs 31A to 31D.

(Advantage of the Third Embodiment)

According to this third embodiment, because the distribution circuits 33A to 33D are modularized, downsizing of the signal processing device employing the optical distribution module 1 can be achieved in the same manner as in the first embodiment, and it has become easy to design layout of the board on which the optical distribution module is mounted, and the components. Moreover, the distribution circuit 33 can be of such a structure employing the optical fibers, as in the prior art. In this case, the optical fibers are used only for the optical transmission inside the optical distribution module, but are not used for connection with the exterior. Therefore, such inconveniences as in the prior art will not happen.

### Fourth and Fifth Embodiments

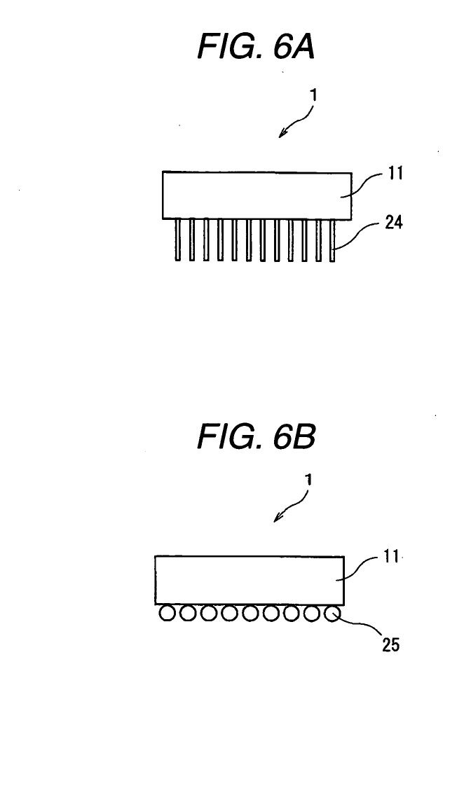

FIG. 6A shows an optical distribution module according the fourth embodiment, and FIG. 6B shows an optical distribution module according the fifth embodiment.

Although the optical distribution module 1 is of DIP (Dual In-Line Package) type in the above described first to third embodiments, the optical distribution module 1 in the fourth embodiment is of PGA (Pin Grid Array) type including the package 11 and pins 24. The optical distribution model 1 in the fifth embodiment is of BGA (Ball Grid Array) type in which soldered balls 25 are provided on a bottom face of the package 11.

According to the fourth and fifth embodiments, it is possible to select an optimal shape of the package, according to a shape of the circuit board on which the optical distribution module 1 is mounted, and a manner of mounting the components to be mounted on the mother board.

### Sixth Embodiment

FIG. 7 shows the signal processing device according to the sixth embodiment of the invention. This signal processing device 100 can be used in a device or system such as a RAID (Redundant Arrays of Independent/Inexpensive Disk), a storage server, an exchanger, a semiconductor disk, and includes a mother board 41 and a plurality of memory boards 43A to 43D which are connected to the mother board 41.

On the mother board 41, there are mounted the optical distribution module 1 according to the first embodiment, a CPU 44, and a plurality of connectors 42A to 42D provided at a determined interval. Moreover, the mother board 41 is connected to other circuit boards and a power supply source, whereby transmission of signals with the other circuit boards and supply of power to respective parts on the mother board 41 will be conducted.

The CPU 44 controls an entirety of the signal processing device 100. Although not shown in FIG. 7, a clock generating circuit, a crystal oscillator, an interface circuit, and other electronic parts related to the CPU 44 are actually mounted on the mother board 41.

The memory boards 43A to 43D can be detachably attached to an upper face of the mother board 41 by means of the connectors 42A to 42D. A plurality of DRAMs (Dynamic Random Access Memory) 45 are mounted on the memory boards 43A to 43D, and peripheral ICs related to the DRAM 45 are mounted according to necessity. Although the memory to be mounted is the DRAM in this embodiment, other types of memory such as a SRAM, a flash memory, for example, may be employed.

(Advantage of the Sixth Embodiment)

According to the sixth embodiment, because the optical distribution module 1 having a compact structure is mounted on the signal processing device 100 in which optical signal transmitting system is incorporated, downsizing of the device can be achieved, and branching of the signal can be performed easily. Moreover, because connection of the optical fibers is not conducted on the mother board 41, structure of the device can be simplified. Further, signal transmission between the mother board 41 and the memory boards 43A to 43D constituting the connection of 1:N can be performed at high speed.

### Seventh Embodiment

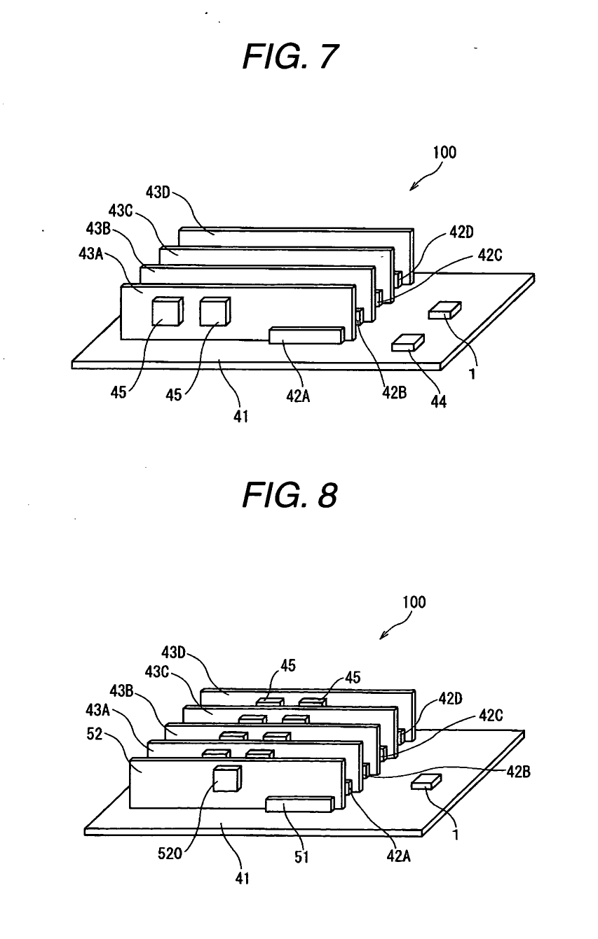

FIG. 8 shows a signal controlling device according to the seventh embodiment of the invention. In this embodiment, a connector 51, and a CPU board 52 to be inserted into this connector 51 are additionally provided on the mother board 41 in the sixth embodiment, while the CPU 44 is removed from the mother board 41. Structures of the other parts are substantially the same as in the sixth embodiment.

The CPU board 52 carries the CPU 520, which controls the mother board 41 and the memory boards 43A to 43D. Moreover, a clock generating circuit, a crystal oscillator, an interface circuit, and other electronic parts related to the CPU 520 are mounted on the CPU board 52.

(Advantage of the Seventh Embodiment)

According to this seventh embodiment, transmission of signals between the CPU board 52 and the memory boards 43A to 43D constituting the connection of 1:N can be performed at high-speed. Moreover, functions of the CPU can be easily changed, by exchanging the CPU board 52. As the results, it is possible to modify specification of the signal processing device 100, and to enhance performance of the device.

According to the above-embodiments, because the distribution circuit is modularized, it has become unnecessary to conduct connection between the optical distribution module and other devices or circuits by means of optical fibers, in the connection of 1:N. Accordingly, downsizing of the device employing the optical distribution module can be achieved. Because the optical signal is branched or coupled by the distribution circuit, high speed transmission will be made possible.

In case where the one light emitting element and a plurality of the light receiving element are used, it is possible to combine them with the distribution circuit for conducting optical branch, and in case where a plurality of the light emitting elements and the one light receiving element are used, it is possible to combine them with the distribution circuit for conducting optical coupling. It is also possible to combine a plurality of the light emitting elements and a plurality of the light receiving elements with the distribution circuit which conducts optical branch and/or optical coupling.

As the light emitting element, a light emitting diode, a laser diode or the like may be used. The laser diode may include a surface emitting type semiconductor laser or an end face emitting type semiconductor laser.

The aforesaid optical distribution module may have such a structure that the distribution circuit includes a light guide body having light transparency and a length extending from the light emitting element to the light receiving element, and the light guide body has a plurality of light guide paths which have respectively different lengths, and the light guide paths are respectively provided with inclined faces at both ends thereof. In this structure, one of the inclined faces provided at both the ends of the light guide path will serve as an incident face of the optical signal from the light emitting element, and the other inclined face will serve as an emitting face of the optical signal to the light receiving element.

As material for the light guide body, plastic material such as polymethyl methacrylate, polycarbonate, amorphous polyolefin, and inorganic glass, etc. may be used. The light guide body formed of the plastic material can be produced by injection molding or other processes. In case where the inorganic glass is used as the material for the light guide body, the inclined faces can be formed by grinding work. Further, it is possible to produce the light guide body from epoxy resin or the like of ultraviolet setting type, using a determined mold.

According to the above-embodiments, because the distribution circuit is modularized, it has become unnecessary to conduct connection between the optical distribution module and other devices or circuits by means of optical fibers, in the connection of 1:N. Accordingly, downsizing of the device employing the optical distribution module can be achieved. Because the optical signal is branched or coupled by the distribution circuit, high speed transmission will be made possible. Because the array of the light emitting elements and the array of the light receiving elements are employed, the module can be easily assembled, as compared with a case in which the light emitting elements and light receiving elements are individually arranged, and thus, downsizing of the device can be achieved.

The optical distribution module may have such a structure that the distribution circuit includes a light guide body having light transparency and a length extending from the light emitting element array to the light receiving element array, the light guide body has a plurality of light guide paths which have respectively different lengths, the light guide paths are respectively provided with inclined faces at both ends thereof, and the light emitting element array and the light receiving element array are arranged at determined intervals so as to intersect the light guide paths at the right angle.

The optical distribution module may have such a structure that the distribution circuit includes at least one Y-shaped branching light guide path which is formed in a Y-shape having at least one step, whereby the light emitting element and the light receiving element are optically coupled. According to this structure, it is possible to reduce a difference in length between the light paths of the signal light. The distribution circuit is produced by forming a core part of the light guide path from acryl resin, epoxy resin or polyimide resin, for example, and then, by forming a clad of fluoric polymer or the like having a smaller index of refraction than the core part, around the core part. Such distribution circuit can be produced by semiconductor process.

The optical distribution module may have such a structure that the distribution circuit includes a light guide plate having an incident face and an emitting face, at least one optical fiber at an incident side for optically coupling the incident face of the light guide plate and the light emitting element, and at least one optical fiber at an emitting side for optically coupling the emitting face of the light guide plate and the light receiving element. In this structure, one of the inclined faces provided at both the ends of the light guide path will serve as an incident face of the optical signal from the light emitting element, and the other inclined face will serve as an emitting face of the optical signal to the light receiving element.

The optical distribution module may include an electrical interface part which can be connected to a circuit board or the like.

The optical distribution module may have such a structure that the above described light emitting element, light receiving element, and distribution circuit are mounted on a board, and the board is held by a package of DIP (Dual In-Line Package) type, PGA (Pin Grid Array) type, or BGA (Ball Grid Array) type.

According to the above-embodiments, the signal processing device may have such a structure that transmission of the light is conducted in the optical distribution module, while only transmission of the electrical signal is conducted on the board.

According to the embodiments, the signal processing device may have such a structure that transmission of the light is conducted in the optical distribution module, while only transmission of the electrical signal is conducted on the mother board. Moreover, signal transmission between the mother board constituting the connection of 1:N and a plurality of the memory boards can be performed at high speed.

According to the embodiments, the signal processing device may have such a structure that transmission of the light is conducted in the optical distribution module, while only transmission of the electrical signal is conducted on the mother board. Moreover, signal transmission between the CPU board constituting the connection of 1:N and a plurality of the memory boards can be performed at high speed.

According to the embodiments, the distribution circuit is modularized, and therefore, it has become possible to conduct high speed transmission in the connection of 1:N, with a small-sized device.

The present invention is not limited to the respective embodiments as described above, but various modifications can be made within a scope not deviated from a gist of the invention. Although the distribution circuit is employed to branch the light in the above described embodiments, it is also possible to couple optical waves. Moreover, constituent elements in the above described embodiments may be combined as desired, within a scope not deviated from the gist of the invention.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined solely by the following claims and their equivalents.

What is claimed is:

1. An optical distribution module, comprising:
at least one light emitting element that converts an optical signal to an electrical signal;
at least one light receiving element that converts the optical signal to the electrical signal; and
a distribution circuit that is arranged so as to optically couple the light emitting element and the light receiving element, the distribution circuit that split or couples the optical signal from the light emitting element so as to emit the optical signal to the light receiving element.

2. An optical distribution module according to claim 1, wherein the distribution circuit comprises a light guide body having light transparency and a length extending from the light emitting element to the light receiving element, wherein the light guide body has a plurality of light guide paths which have respectively different lengths, and wherein the light guide paths has inclined faces at both ends of the light guide paths.

3. An optical distribution module comprising:
at least one light emitting element array having a plurality of light emitting elements that convert an optical signal to an electrical signal;
at least one light receiving element array having a plurality of light receiving elements that convert the optical signal to the electrical signal; and
a distribution circuit that is arranged so as to optically couple the light emitting element array and the light receiving element array, the distribution circuit that split or couples the optical signal from the light emitting element array so as to emit the optical signal to the light receiving element array.

4. An optical distribution module according to claim 3, wherein the distribution distribution circuit includes a light guide body having light transparency and a length extending from the light emitting element array to the light receiving element array,
wherein the light guide body has a plurality of light guide paths which have respectively different lengths,
wherein the light guide paths are respectively provided with inclined faces at both ends thereof, and
wherein the light emitting element array and the light receiving element array are arranged at determined intervals so as to intersect the light guide paths at the right angle.

5. An optical distribution module according to claim 1, wherein the distribution circuit comprises at least one Y-shaped branching light guide path,
wherein the at least one Y-shaped branching light guide path is formed in a substantially Y-shape, and
wherein the at least one Y-shaped branching light guide path comprise at least one step so as to optically couple the light emitting element and the light receiving element.

6. An optical distribution module according to claim 1, wherein the distribution circuit comprises a light guide plate having an incident face and an emitting face, at least one optical fiber at an incident side for optically coupling the incident face of the light guide plate and the light emitting element, and at least one optical fiber at an emitting side for optically coupling the emitting face of the light guide plate and the light receiving element.

7. An optical distribution module according to claim 1, wherein the optical distribution model comprises an electrical interface part capable of being connected to a circuit board.

8. An optical distribution module according to claim 1, wherein the light emitting element, the light receiving element, and the distribution circuit are mounted on a board, and the board is held by a package of DIP (Dual In-Line Package) type, PGA (Pin Grid Array) type, or BGA (Ball Grid Array) type.

9. A signal processing device comprising:
a board on which the optical distribution module according to claim 1 is mounted, wherein the board transmitting and receiving the electrical signal to and from the optical distribution module.

10. A signal processing device comprising:
a mother board on which the optical distribution module according to claim 1 and a CPU are mounted; and
a plurality of memory boards being connected to the mother board, and the plurality of memory boards having a semiconductor memory.

11. A signal processing device comprising:
a mother board on which the optical distribution module according to claim 1 is mounted;
a plurality of memory boards being connected to the mother board, and the plurality of memory boards having a semiconductor memory; and
a CPU board carrying a CPU, and the CPU being connected to the mother board.
